(19) United States
(12) Patent Application Publication
(10) Pub. No.: US 2007/0272654 A1
(43) Pub. Date: Nov. 29, 2007

(54) Method for Manufacturing Circuit Board

(75) Inventor: Chun-Hsiang Huang, Xinpu Town (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ADVANCED SEMICONDUCTOR ENGINEERING INC., Kaohsiung (TW)

(21) Appl. No.: 11/626,945

(22) Filed: Jan. 25, 2007

(30) Foreign Application Priority Data
May 25, 2006 (TW) 95118564

(51) Int. Cl. H01B 13/00; C23F 1/00

(52) U.S. Cl. 216/13; 216/41; 216/58

(57) ABSTRACT

A method for manufacturing a circuit board is described. A core layer of substrate comprising an insulating layer, at least one through hole and a first copper layer including a face copper and a hole copper is provided. A first photo-resist layer is formed on the face copper and defines a circuit region on the hole copper and the face copper. A second copper layer is plated on the circuit region. A second photo-resist layer is formed on the second copper and the first photo-resist layer, and defines first electrically connecting regions on the second copper layer. A metal layer is plated on the first electrically connecting regions. The first and second photo-resist layers are removed. The face copper and the second copper layer are etched to a predetermined depth to form a circuit, wherein the predetermined depth is not less than a predetermined thickness of the face copper.

### RELATED APPLICATIONS

The present application is based on, and claims priority from, Taiwan Application Serial Number 95118564, filed May 25, 2006, the disclosure of which is hereby incorporated by reference herein in its entirety.

### FIELD OF THE INVENTION

The present invention relates to a circuit board, and more particularly, to a method for manufacturing a circuit board without an electroplating wire, wherein the plating wire is etched away completely when a face copper in a non-circuit region is etched in the present method.

### BACKGROUND OF THE INVENTION

Printed circuit boards (PCBs) are manufactured by drawing the layout of electrical wires for connecting circuit elements to form a layout drawing according to a circuit design, and then reconstructing electrical conductors on an insulator by machining and surface treating methods according to the designation of the design. Copper clad laminates (CCLs) are critical and basic materials for manufacturing the printed circuit boards. The copper clad laminates are formed by stacking insulating papers, fiberglass cloth or other fiber materials with prepregs immersed by epoxy, and then covering copper foil on single face or double faces of each laminate under high temperature and high pressure. In the conventional fabrication process, precise wirings used for connecting electric components are formed by printing, photographing, etching and plating. Therefore, high density and multi-layer wiring forming techniques have become the master stream in the development of the printed circuit board manufacture industry.

Referring to FIGS. 1a through 1k, in the U.S. publication No. 2005/0241954 entitled “Electrolytic Gold Plating Method Of Printed Circuit Board”, a method for manufacturing a printed circuit board with a plating wire is disclosed in the applicants' admitted prior art. Referring FIG. 1a, an upper copper clad layer 11b and a lower copper clad layer 11b are coated on an upper side and a lower side of an insulating epoxy layer 11a to form a copper clad laminate 11. Referring to FIG. 1b, a through hole b passes through the insulating epoxy layer 11a. Referring to FIG. 1c, an electroless copper plating layer 12 is formed on the whole upper copper clad layer 11b, the whole lower copper clad layer 11b and a surface of the through hole b to electrically connect the upper copper clad layer 11b and the lower copper clad layer 11b. Referring to FIG. 1d, an electrolytic copper plating layer 13 is formed on the copper plating layer 12, wherein the copper plating layer 13 has a good physical property. Referring to FIG. 1e, a dry film 20 is coated on the copper plating layer 13, and the dry film 20 is defined to have a predetermined pattern by a first exposure and development process. The predetermined pattern includes a wire, the through hole b, a bonding pad for wire bonding and a plating wire. Referring to FIG. 1f, the upper copper clad layer 11b, the lower copper clad layer 11b, the copper plating layer 12 and the copper plating layer 13 not covered by the dry film 20 are etched, wherein the dry film 20 is used as an etching resist. Referring to FIG. 1g, the dry film 20 is removed. Referring to FIG. 1h, a solder mask layer 14 is coated on the patterned copper clad laminate 11. Referring to FIG. 1i, a photomask layer 30 with a predetermined pattern is deposed on the solder mask layer 14. Referring to FIG. 1j, the solder mask layer 14 is patterned to form the predetermined pattern by an exposure and development process, wherein the predetermined pattern of the solder mask layer 14 is defined with an opening c, and the opening c defines an end connector for wire bonding. Referring to FIG. 1k, an electrolytic gold plating layer 15 is formed in the opening c of the solder mask layer 14. After cutting, a printed circuit board 10 is completed, such as shown in FIG. 2.

Referring to FIG. 2 again, plating wires 16 have to be formed for the electrolytic plating process. Though the plating wires 16 have been cut, a portion of the plating wires 16 will remain, and the conventional printed circuit board 10 still includes the remaining plating wires 16, such as shown within a region indicated by an elliptical dotted line in FIG. 2. However, the remnant of the plating wires 16 will induce noise or parasitic inductance when the electrical signal is transmitted in the printed circuit board 10, so as to lower the performance of the printed circuit board 10.

Accordingly, a method for manufacturing a printed circuit board without a plating wire have been developed to overcome the disadvantages of the method for manufacturing a printed circuit board with a plating wire. Although the U.S. publication No. 2005/0241954 also discloses an electrolytic gold plating method, which can manufacture a printed circuit board 40 without plating wire, such as shown within a region indicated by an elliptical dotted line in FIG. 3, the process is so complicated, thereby increasing the process time.

Moreover, another conventional method for manufacturing a printed circuit board without a plating wire is a gold plating pattern (GPP) process. Referring to FIG. 4a, a copper clad laminate 51 is provided, and the copper clad laminate 51 comprises an insulating layer 51a, at least one through hole d and a first copper layer 70, wherein the through hole d passes through the insulating layer 51a. The first copper layer 70 includes a face copper 72 and a hole copper 74. The face copper 72 is deposed on an upper surface 76 and lower surface 78 of the whole insulating layer 51a, wherein the face copper 72 comprises an upper copper clad layer 51b, a lower copper clad layer 51b, an electroless copper plating layer 52. The hole copper 74 is deposed on a surface of the through hole d, wherein the hole copper 74 comprises an electroless copper plating layer 52. Referring to FIG. 4b, a second copper layer, such as an electrolytic copper plating layer 53, is formed on the face copper 72 and the hole copper 74, wherein the copper plating layer 53 has a good physical property. Referring to FIG. 4c, an upper dry film 60 and a lower dry film 60 are respectively formed on the copper plating layer 53 on the upper surface 76 and the lower surface 78, and the dry film 60 is defined to have a predetermined pattern by an exposure and development process. The predetermined pattern is a non-circuit region including no wire, through hole and bonding pad for wire bonding, i.e. the predetermined pattern exposes the through hole d, a portion area of the copper plating layer 53 on the upper surface 76 and a portion area of the copper plating layer 53 on the lower surface 78 to define a circuit region.

Referring to FIG. 4d, an electrolytic gold plating layer 55 is formed on the whole circuit region. Referring to FIG. 4e, the upper dry film 60 and the lower dry film 60 are removed. Referring to FIG. 4f, the face copper 72 and the copper plating layer 53 not covered by the gold plating layer 55 are directly etched away, so as to form a circuit in the circuit region. Referring to FIG. 4g, a solder mask layer 54 is formed on the circuit and exposes a portion of the gold plating layer 55 to define a bonding bad for wire bonding.

Although the convention gold plating pattern process is simpler, the electrolytic gold plating layer is formed on the whole circuit region, thereby increasing the process cost.

Therefore, it is needed to provide a method for manufacturing a printed circuit board that can solve the aforementioned disadvantages.

### SUMMARY OF THE INVENTION

One aspect of the present invention is to provide a method for manufacturing a circuit board without plating wire, in which a plating wire is completely etched away when a face copper in a non-circuit region is etched.

Another aspect of the present invention is to provide a method for manufacturing a circuit board without plating wire, in which the gold/nickel plating layer is not formed on the whole circuit region.

Still another aspect of the present invention is to provide a method for manufacturing a circuit board without plating wire, in which a first photo-resist layer and a second photo-resist layer can be removed simultaneously.

According to the aforementioned aspects, the present invention provides a method for manufacturing a circuit board, comprising: (a) providing a core layer of substrate comprising an insulating layer, at least one through hole and a first copper layer, wherein the through hole passes through the insulating layer, the first copper layer includes a face copper and a hole copper, the face copper is disposed on a whole upper surface and a whole lower surface of the insulating layer, the hole copper is deposed on a surface of the through hole, and the face copper has a predetermined thickness; (b) forming a first photo-resist layer on the face copper, and patterning the first photo-resist layer to expose the hole copper and a portion of the face copper to define a circuit region; (c) plating a second copper layer on the circuit region; (d) forming a second photo-resist layer on the second copper and the first photo-resist layer, and patterning the second photo-resist layer to expose a portion area of the second copper layer in the circuit region, wherein the portion area of the second copper layer on the upper surface defines a plurality of first electrically connecting regions; (e) plating a metal layer on the first electrically connecting regions for forming a plurality of first electrical connectors on the upper surface; (f) removing the first photo-resist layer and the second photo-resist layer; and (g) directly etching the exposed face copper and the exposed second copper layer to a predetermined depth to form a circuit in the circuit region, wherein the predetermined depth is not less than the predetermined thickness of the face copper.

According to the method for manufacturing a circuit board of the present invention, when the face copper in the non-circuit region is etched, the plating wires (a portion of the face copper) are also etched away simultaneously, so that there is no plating wire remaining in the circuit board of the present invention. Besides, as compared with the prior arts, the metal layer of the present invention, such as a gold/nickel plating layer, is not formed on the whole circuit region, so that the total process cost is not increased.

The foregoing aspects and many of the attendant advantages of this invention are more readily appreciated as the same become better understood by reference to the following detailed description, when taken in conjunction with the accompanying drawings

### BRIEF DESCRIPTION OF THE DRAWINGS

FIGS. 1a through 1k are schematic flow diagrams showing the process for manufacturing a conventional printed circuit board with a plating wire;

FIG. 2 illustrates a top view of a portion of a conventional printed circuit board with a plating wire, which showing the printed circuit board still includes the remaining plating wires;

FIG. 3 illustrates a top view of a portion of a conventional first printed circuit board without a plating wire, which showing the printed circuit board includes no plating wire;

FIGS. 4a through 4g are schematic flow diagrams showing the process for manufacturing a conventional second printed circuit board without a plating wire;

FIG. 5 is a flow chart of a method for manufacturing a circuit board without a plating wire in accordance with a preferred embodiment of the present invention;

FIGS. 6a through 6h are schematic flow diagrams showing the process for manufacturing a circuit board without a plating wire in accordance with a preferred embodiment of the present invention; and

FIG. 7 illustrates a top view of a portion of a circuit board without a plating wire in accordance with a preferred embodiment of the present invention, which showing the printed circuit board includes no plating wire.

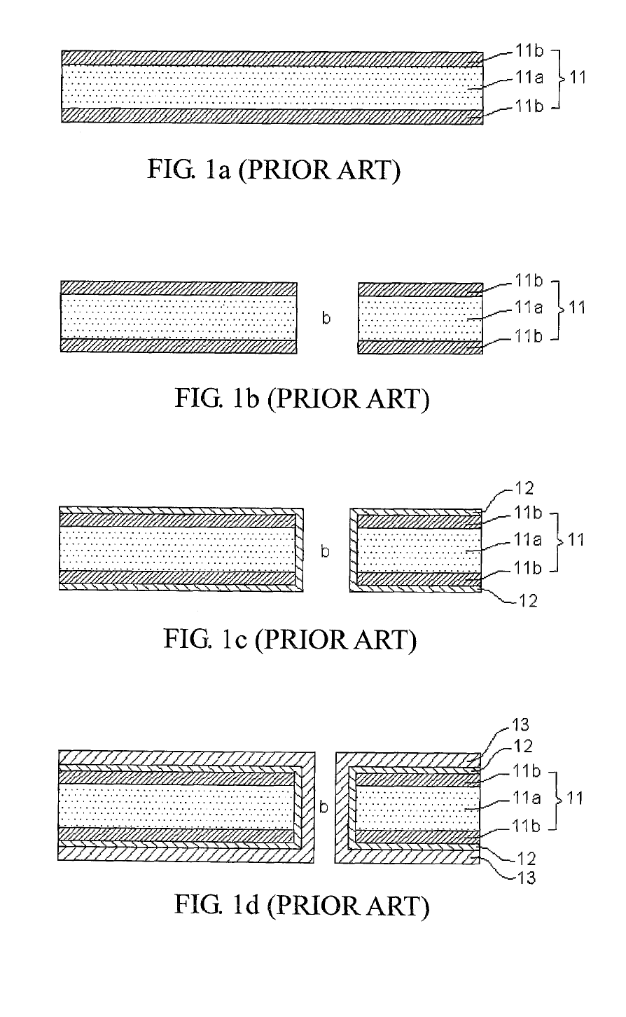

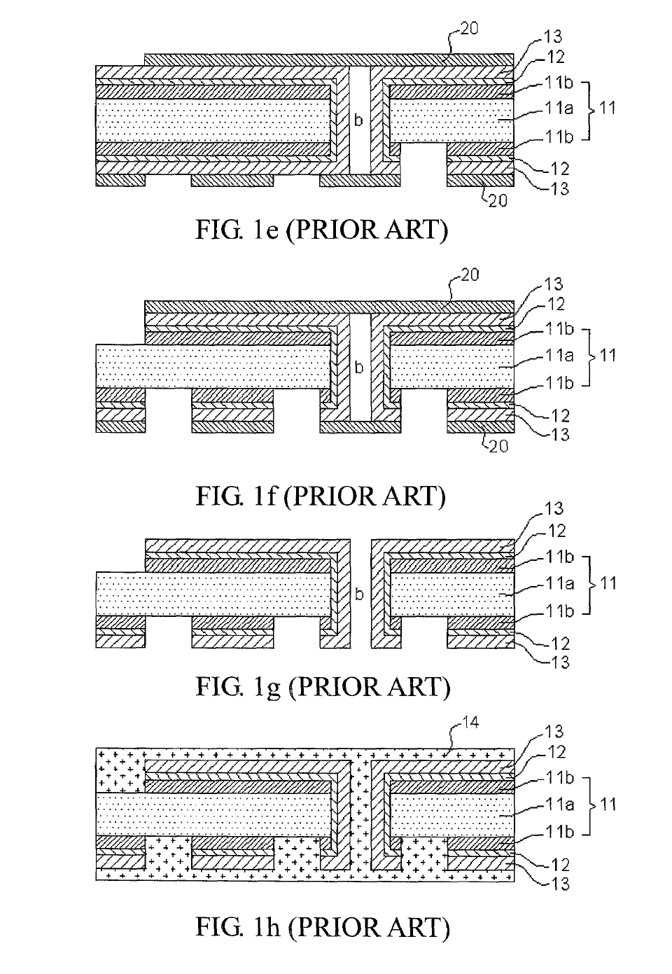

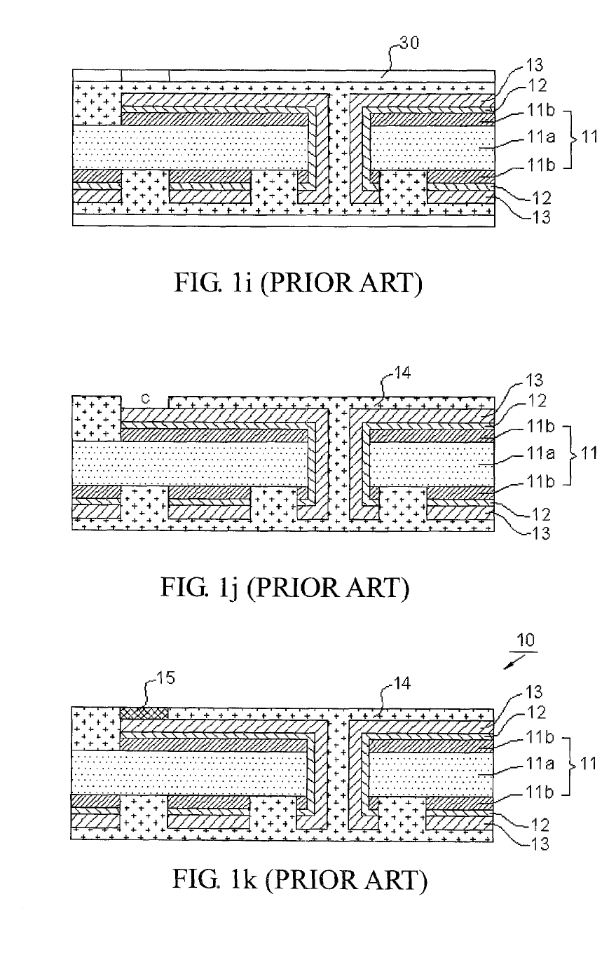

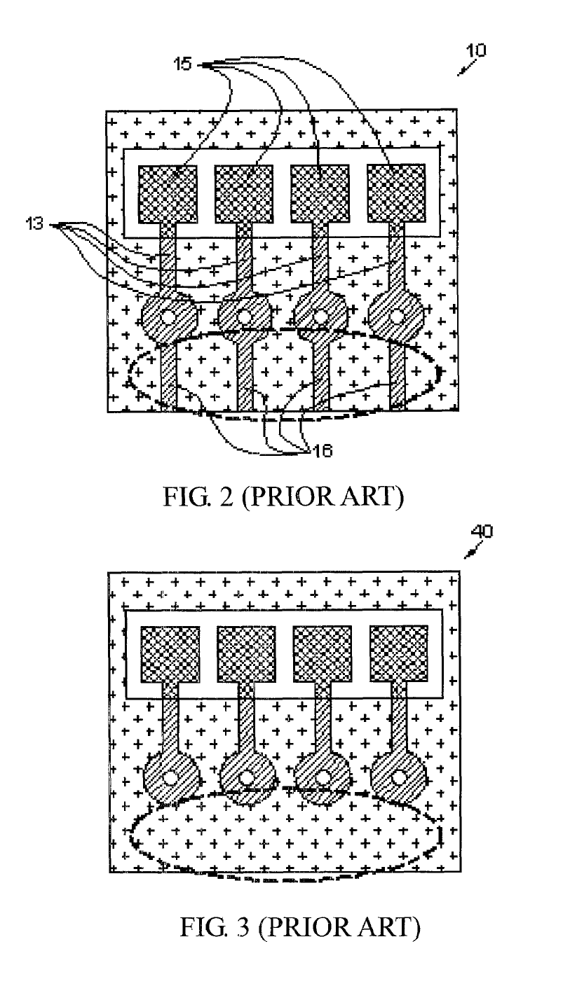

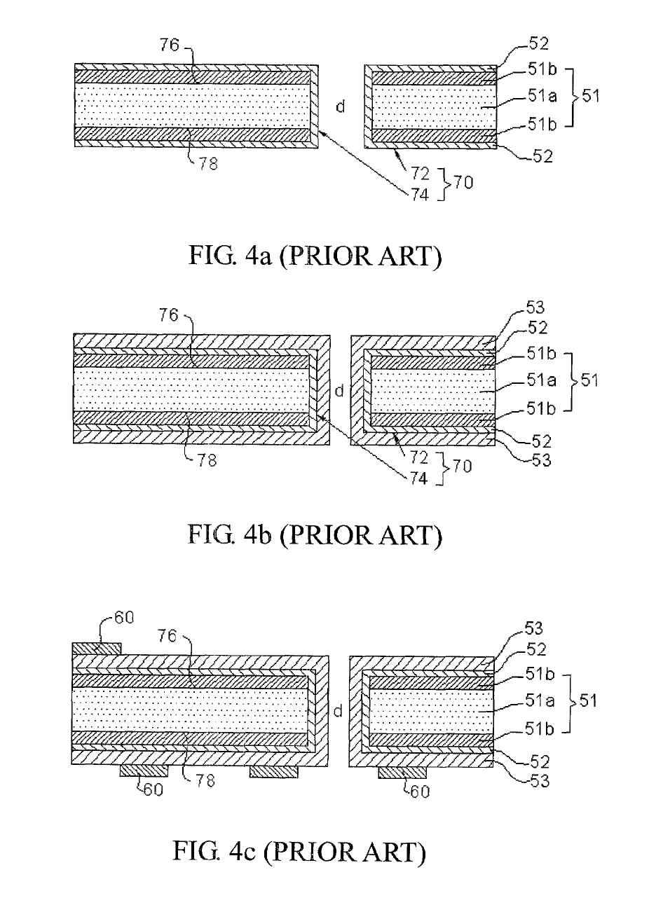

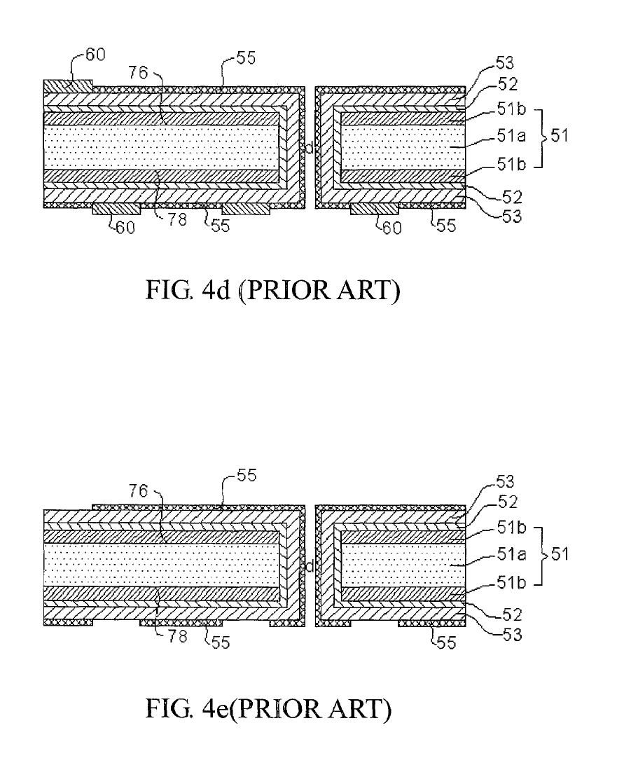

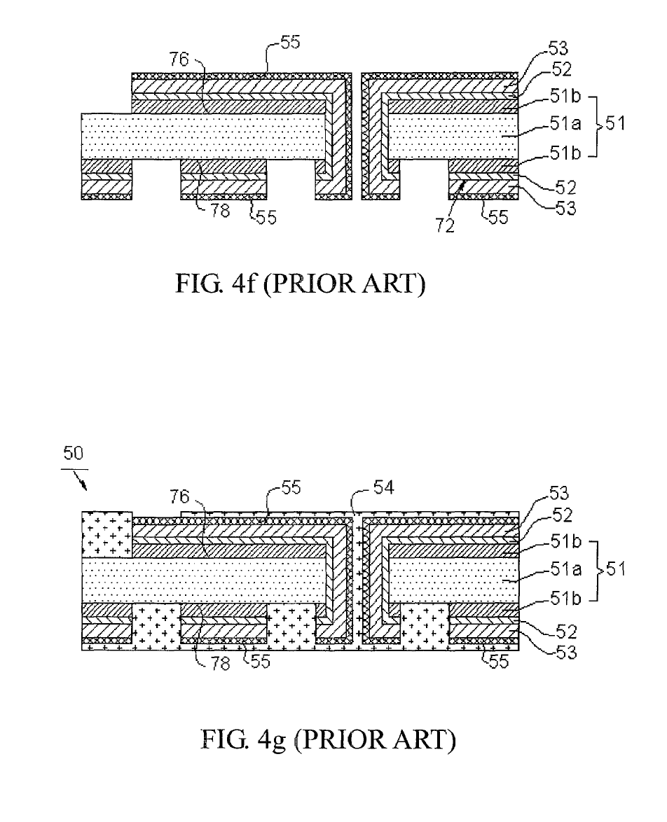

### DETAILED DESCRIPTION OF THE PREFERRED EMBODIMENT

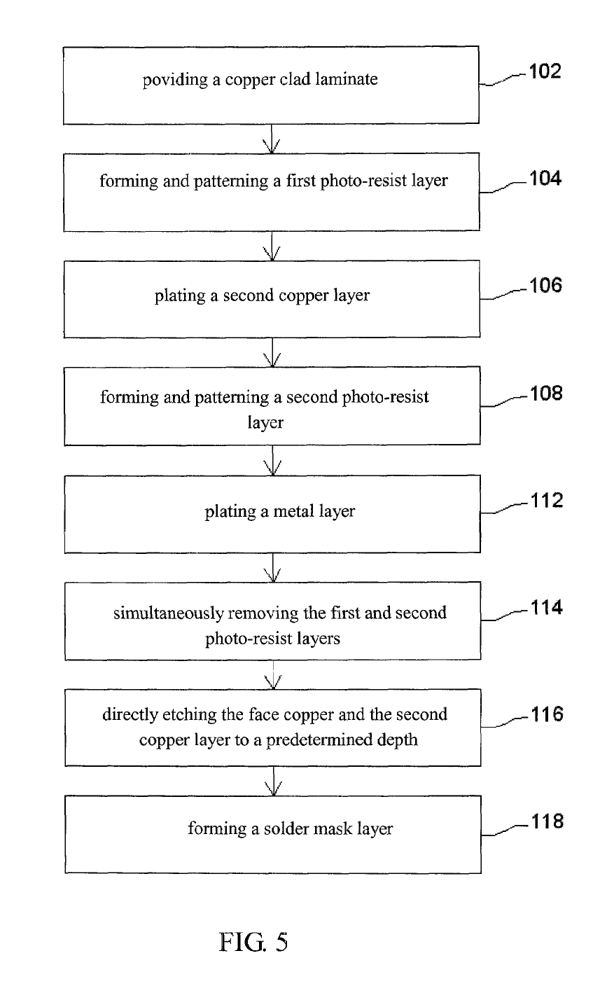

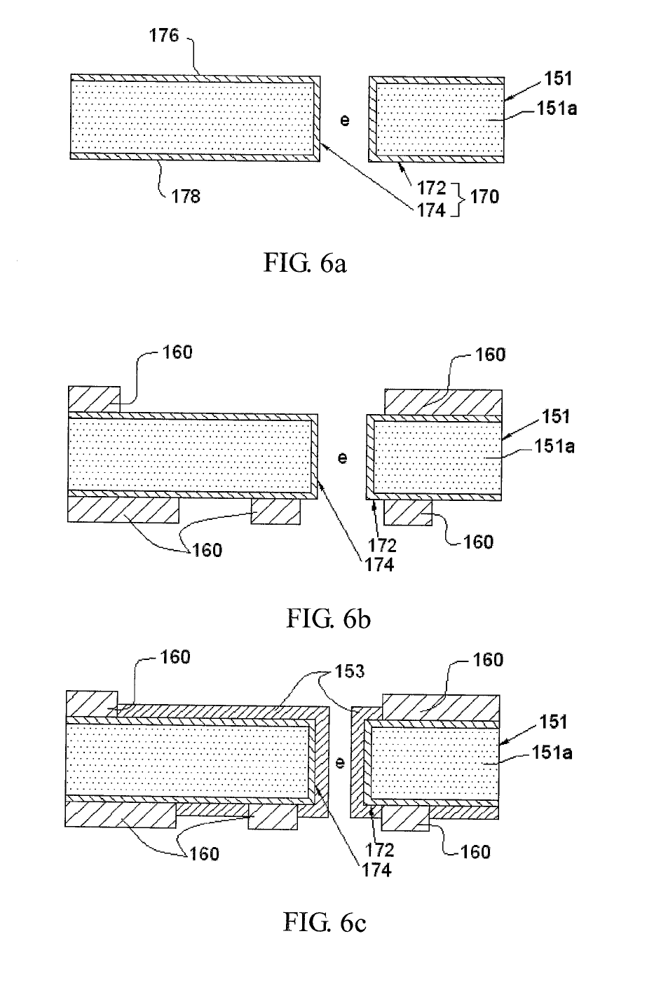

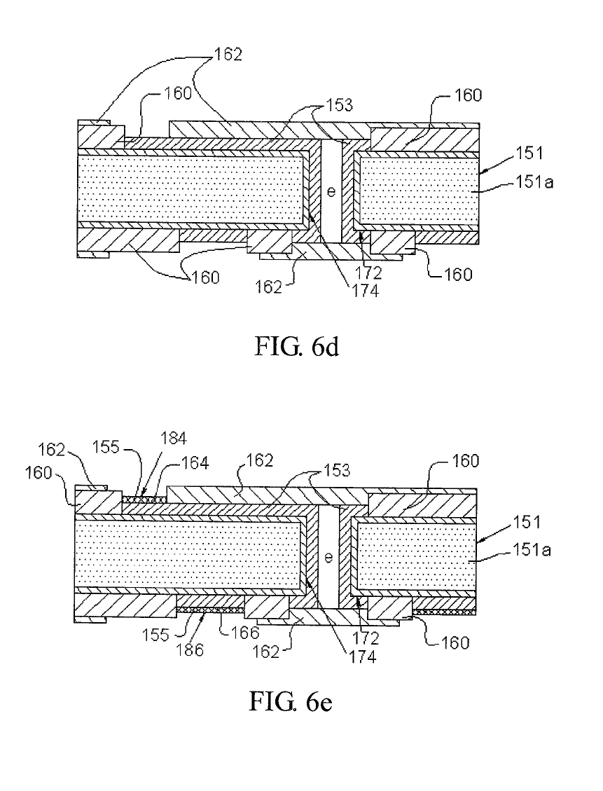

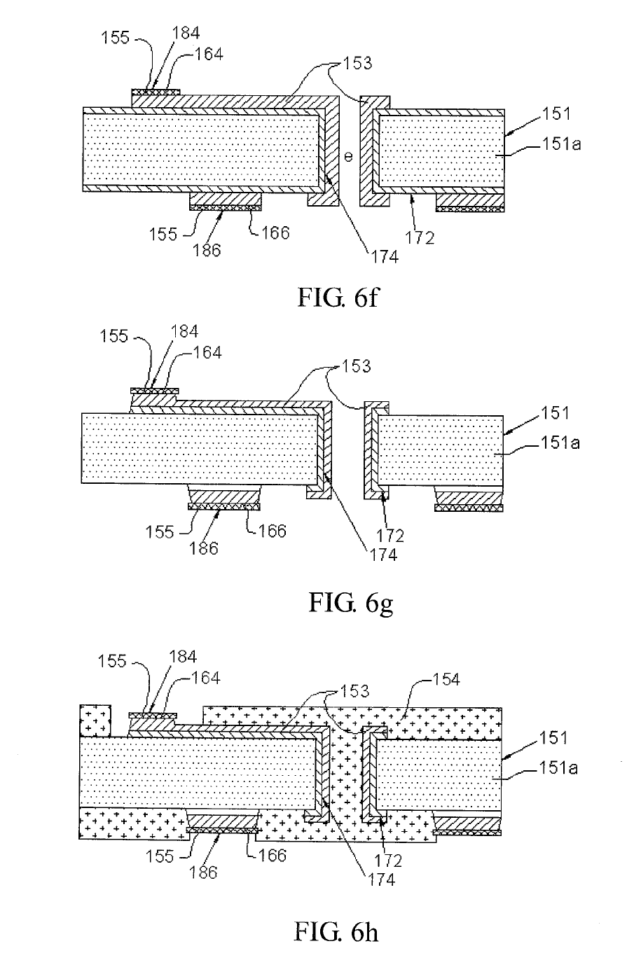

Referring to FIG. 5 and FIGS. 6a through 6h, respectively illustrating a flow chart and schematic flow diagrams showing the process for manufacturing a circuit board without a plating wire in accordance with a preferred embodiment of the present invention. The method comprises the following steps. Referring to FIG. 6a, in the step 102, a core layer of substrate (such as a copper clad laminate 151 with double-layer circuits) is provided, wherein the copper clad laminate 151 comprises an insulating layer 151a, at least one through hole e and a first copper layer 170. The insulating layer 151a includes an upper surface 176 and a lower surface 178 opposite to the upper surface 176. The through hole e extends from the upper surface 176 to the lower surface 178, i.e. the through hole e passes through the insulating layer 151a. The first copper layer 170 comprises a face copper 172 and a hole copper 174, wherein the face copper 172 is deposed on the upper surface 176 and the lower surface 178 of the whole insulating layer 151a, and the hole copper is deposed on a surface of the through hole e. In detail, the face copper 172 may comprise an upper copper clad layer, a lower copper clad layer and an electroless copper plating layer as described in the prior art, and the hole copper 174 may comprise an electroless copper plating layer as described in the prior art. The face copper 172 has a predetermined thickness, such as 10 μm, and the hole copper 174 has a predetermined thickness, such as 7 μm. The person having ordinary skill in the art knows that the core layer of substrate may also be a pressed copper clad laminate composed of a plurality of circuit layers, or may be a build-up copper clad laminate composed of a plurality of circuit layers.

Referring FIG. 6b, in the step 104, a first photo-resist layer, such as an upper photo-resist layer 160 and a lower photo-resist layer 160 is formed, wherein the upper photo-resist layer 160 and the lower photo-resist layer 160 are respectively formed on the surface copper 172 on the upper surface 176 and the lower surface 178. The upper photo-resist layer 160 and the lower photo-resist layer 160 may be dry films. Then, the upper photo-resist layer 160 and the lower photo-resist layer 160 are defined to form a predetermined pattern by an exposure and development process. The predetermined pattern is defined as a non-circuit region including no wire, through hole and electrical connector, i.e. the predetermined pattern exposes the hole copper 174, a portion area of the face copper 172 on the upper surface 176 and a portion area of the face copper 172 on the lower surface 178 to define a circuit region.

Referring to FIG. 6c, in the step 106, a second copper layer 153 is plated on the circuit region by, for example, an electrolytic plating process, wherein the second copper layer 153 has a good physical property. The second copper layer 153 has a predetermined thickness, such as 25 μm, therefore a total thickness of the face copper 172 and the second copper layer 153 is 35 μm, and a total thickness of the hole copper 174 and the second copper layer 153 is 32 μm.

Referring to FIG. 6d, in the step 108, a second photo-resist layer, such as a second upper photo-resist layer 162 and a second lower photo-resist layer 162, is formed, wherein the second upper photo-resist layer 162 is formed on the second copper layer 153 and the first upper photo-resist layer 160 on the upper surface 176, and the second lower photo-resist layer 162 is formed on the second copper layer 153 and the first lower photo-resist layer 160 on the lower surface 178. The second upper photo-resist layer 162 and the second lower photo-resist layer 162 may be dry films. Then, the second upper photo-resist layer 162 and the second lower photo-resist layer 162 are patterned to expose a portion area of the second copper layer 153 by another exposure and development process, wherein the exposed area of the second copper layer 153 on the upper surface 176 is used to define a plurality of first electrically connecting regions 164, and the exposed area of the second copper layer 153 on the lower surface 178 is used to define a plurality of second electrically connecting regions 166.

Referring to FIG. 6e, in the step 112, a metal layer 155 is plated on the first electrically connecting regions 164 and the second electrically connecting regions 166 by, for example, an electrolytic plating process, to form a plurality of first electrical connectors 184 and a plurality of second electrical connectors 186 simultaneously. The metal layer 155 may be a gold/nickel plating layer. The gold/nickel plating layer is not formed on the whole circuit region, so the process cost cannot be increased. The first electrical connectors 184 may be bonding pads for wire bonding, bonding pads for flip-chip bonding or golden fingers for connecting end connectors. The second electrical connectors 186 may be bonding pads for soldering with solder balls.

Referring to FIG. 6f, in the step 114, the first upper photo-resist layer 160, the first lower photo-resist layer 160, the second upper photo-resist layer 162, the second lower photo-resist layer 162 are removed. Preferably, the first upper photo-resist layer 160, the first lower photo-resist layer 160, the second upper photo-resist layer 162, the second lower photo-resist layer 162 are removed simultaneously.

Referring to FIG. 6g, in the step 116, the exposed face copper 172 and the exposed second copper layer 153 are directly etched to a predetermined depth, wherein the predetermined depth is not less than (i.e. greater than or equal to) the predetermined thickness of the face copper 172. Preferably, the predetermined depth is greater than the predetermined thickness of the face copper 172. Because the predetermined depth (such as 12 μm) is greater than the predetermined thickness (10 μm) of the face copper 172, the face copper 172 in the non-circuit region can be removed completely, so as to form a circuit in the circuit region. After etching, the total thickness of the face copper 172 and the second copper layer 153 is 23 μm, and the total thickness of the hole copper 174 and the second copper layer 153 is 20 μm. Furthermore, when the face copper 172 in the non-circuit region is etched away, the plating wires (i.e. a portion of the face copper 172) are completely etched away simultaneously.

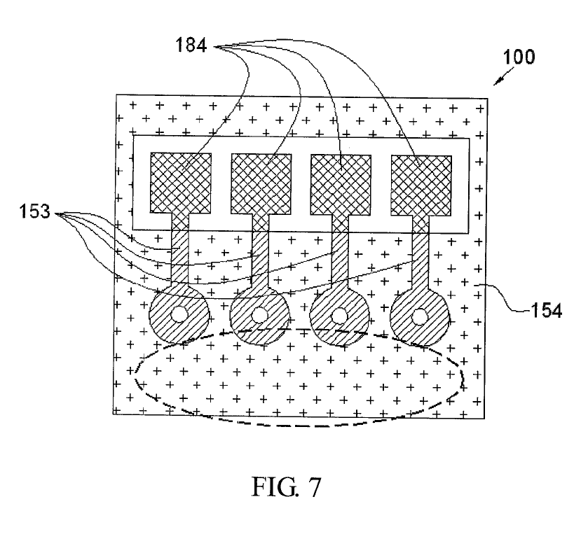

Referring to FIG. 6h, in the step 118, solder mask layer 154 is formed on the circuit and exposes the first electrical connectors 184 and the second electrical connectors 186. After cutting, a single circuit board 100 is formed, such as shown in FIG. 7

According to the method for manufacturing a circuit board of the present invention, when the face copper in the non-circuit region is etched, the plating wires (a portion of the face copper) are also etched away simultaneously, such as within a region indicated by an elliptical dotted line in FIG. 7, so that there is no plating wire remaining in the circuit board of the present invention. Besides, as compared with the prior arts, the gold/nickel plating layer of the present invention is not formed on the whole circuit region, so that the total process cost is not increased. Furthermore, in the method for manufacturing a circuit board, a plurality of first electrical connectors and a plurality of second electrical connectors are simultaneously formed on the upper surface and the lower surface of the insulating layer, and the first photo-resist layer and the second photo-resist layer may be removed simultaneously, so that the process steps and time can be decreased.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for manufacturing a circuit board, comprising:
(a) providing a core layer of substrate comprising an insulating layer, at least one through hole and a first copper layer, wherein the through hole passes through the insulating layer, the first copper layer includes a face copper and a hole copper, the face copper is disposed on a whole upper surface and a whole lower surface of the insulating layer, the hole copper is deposed on a surface of the through hole, and the face copper has a predetermined thickness;
(b) forming a first photo-resist layer on the face copper, and patterning the first photo-resist layer to expose the hole copper and a portion of the face copper to define a circuit region;
(c) plating a second copper layer on the circuit region;
(d) forming a second photo-resist layer on the second copper and the first photo-resist layer, and patterning the second photo-resist layer to expose a portion area of the second copper layer in the circuit region, wherein the portion area of the second copper layer on the upper surface defines a plurality of first electrically connecting regions;
(e) plating a metal layer on the first electrically connecting regions for forming a plurality of first electrical connectors on the upper surface;
(f) removing the first photo-resist layer and the second photo-resist layer; and
(g) directly etching the exposed face copper and the exposed second copper layer to a predetermined depth to form a circuit in the circuit region, wherein the predetermined depth is not less than the predetermined thickness of the face copper.

2. The method for manufacturing a circuit board according to claim 1, wherein in the step (d), the portion area of the second copper layer on the lower surface defines a plurality of second electrically connecting regions, and the step (e) further comprises plating the metal layer on the second electrically connecting regions for forming a plurality of second electrical connectors on the lower surface simultaneously.

3. The method for manufacturing a circuit board according to claim 2, further comprising:
(h) forming a solder mask layer on the circuit and exposing the first electrical connectors and the second electrical connectors.

4. The method for manufacturing a circuit board according to claim 2, wherein the second electrical connectors are bonding pads for soldering with solder balls.

5. The method for manufacturing a circuit board according to claim 1, wherein in the step (f), the first photo-resist layer and the second photo-resist layer are removed simultaneously.

6. The method for manufacturing a circuit board according to claim 1, wherein the first photo-resist layer is a dry film.

7. The method for manufacturing a circuit board according to claim 1, wherein the second photo-resist layer is a dry film.

8. The method for manufacturing a circuit board according to claim 1, wherein the first electrical connectors are bonding pads for wire bonding.

9. The method for manufacturing a circuit board according to claim 1, wherein the first electrical connectors are bonding pads for flip-chip bonding.

10. The method for manufacturing a circuit board according to claim 1, wherein the first electrical connectors are golden fingers for connecting end connectors.

11. The method for manufacturing a circuit board according to claim 1, wherein the metal layer is a gold/nickel plating layer.

12. The method for manufacturing a circuit board according to claim 1, wherein the core layer of substrate is a copper clad laminate with double-layer circuits.

13. The method for manufacturing a circuit board according to claim 1, wherein the core layer of substrate is a pressed copper clad laminate composed of a plurality of circuit layers.

14. The method for manufacturing a circuit board according to claim 1, wherein the core layer of substrate is a build-up copper clad laminate composed of a plurality of circuit layers.

15. The method for manufacturing a circuit board according to claim 1, wherein the predetermined depth is greater than the predetermined thickness of the face copper.
